(19) United States
(12) Patent Application Publication
(10) Pub. No.: US 2025/0363415 A1
(43) Pub. Date: Nov. 27, 2025

(54) TIME STEP GUIDANCE FOR DIFFUSION MODELS

(71) Applicants: DISNEY ENTERPRISES, INC., Burbank, CA (US); ETH Zürich (Eidgenössische Technische Hochschule Zürich), Zürich (CH)

(72) Inventors: Seyedmorteza SADAT, Dübendorf (CH); Manuel Jakob KANSY, Zürich (CH); Romann Matthew WEBER, Uster (CH)

(21) Appl. No.: 19/034,446

(22) Filed: Jan. 22, 2025

Related U.S. Application Data
(60) Provisional application No. 63/650,330, filed on May 21, 2024.

(51) Int. Cl. G06N 20/00

(52) U.S. Cl. CPC G06N 20/00

(57) ABSTRACT

One embodiment of the present invention sets forth a technique for generating data. The technique includes perturbing a first time step embedding corresponding to a first time step in a reverse diffusion process associated with a trained diffusion model to generate a first perturbed time step embedding. The technique also includes generating, via execution of the trained diffusion model, a first perturbed time step score based on a first noise sample associated with the first time step and the first perturbed time step embedding. The technique further includes denoising the first noise sample based on the first perturbed time step score to produce a second noise sample.

### CROSS-REFERENCE TO RELATED APPLICATIONS

This application claims the benefit of the U.S. Provisional Application titled “INDEPENDENT CONDITION AND TIME STEP GUIDANCE FOR DIFFUSION MODELS,” filed on May 21, 2024, and having Ser. No. 63/650,330. The subject matter of this related application is hereby incorporated herein by reference in its entirety.

### BACKGROUND

### Field of the Various Embodiments

Embodiments of the present disclosure relate generally to machine learning and generative models and, more specifically, to time step guidance for diffusion models.

### Description of the Related Art

Generative models refer to deep neural networks and/or other types of machine learning models that are trained to generate new instances of data and/or augment existing data. For example, a generative model may be trained on a training dataset of images of cats. During the training process, the generative model “learns” the visual attributes of various cats depicted in the images. These learned visual attributes may then be used by the generative model to produce new images of cats that are not found in the training dataset. In another example, a generative model may be used to perform denoising, sharpening, blurring, colorization, compositing, super-resolution, inpainting, outpainting, and/or other types of image editing that involves altering the appearance, structure, and/or content of an image.

A diffusion model is one type of generative model. A diffusion model typically includes a forward diffusion process that gradually perturbs input data (e.g., an image) into noise that follows a certain noise distribution over a series of time steps. The diffusion model also includes a reverse denoising process that generates new data by iteratively converting random noise from the noise distribution into the new data over an additional series of time steps. The reverse denoising process is performed by reversing the forward diffusion process and is typically learned by a neural network. For example, the forward diffusion process may gradually add noise to an image of a cat until an image of Gaussian noise is produced. The reverse denoising process may gradually remove noise from an image of Gaussian noise until an image of a cat is produced.

The operation of a diffusion model is frequently conditioned on additional input, such as (but not limited to) a specific text prompt (e.g., “a cat sitting on a beach”) and/or a class label (e.g., a type of animal). The diffusion model may denoise a noise sample by generating, for a given time step in the reverse denoising process, a noise sample based on this additional input. The additional input may thus be used to “steer” the reverse denoising process in a way that satisfies the condition specified in the additional input.

A classifier guidance approach can be used to condition the output of a diffusion model on additional input. During classifier guidance, a separate classifier is trained to predict a target condition (e.g., a class label) based on noise samples generated during the diffusion process. At each denoising step, gradients from the classifier are used to direct the sampling trajectory of the diffusion model toward the target condition, thereby improving alignment between the generated output and the conditioning information. However, this approach involves training the classifier and performing repeated evaluations of the trained classifier during the reverse denoising process, which increases complexity and/or resource overhead associated with the generation of data by a diffusion model.

More recently, classifier-free guidance (CFG) has been developed to streamline the conditional generation process using a diffusion model. Instead of relying on gradients from a separate classifier, CFG operates by combining the output of a conditional model that is guided by a target condition (e.g., a class label or text prompt) with the output of an unconditional model that is not guided by the target condition. At each denoising step, the difference between these outputs is scaled and added back to the prediction by the unconditional model to steer the sampling process toward the target condition.

While CFG avoids the need to train a separate classifier and repeatedly evaluate the classifier during the reverse denoising process, CFG requires simultaneous training of a diffusion model on both conditional and unconditional tasks. This type of training is commonly achieved by randomly substituting a null condition (e.g., a zero vector) for the target condition during training with a predefined probability (e.g., between 10% and 20%.). As a result, computational resources are split between learning the conditional and unconditional score functions, which increases time and resources involved in training the diffusion model. Additionally, it can be difficult to replace a condition with the null condition in a multimodal diffusion model that uses different conditioning signals (e.g., text, images, audio, etc.) and/or in instances when a null vector (e.g., a zero vector) has a specific meaning.

Further, CFG relies on conditioning inputs during both training and sampling processes. Consequently, CFG cannot be used to improve unconditional generation, which lacks conditioning inputs.

As the foregoing illustrates, what is needed in the art are more effective techniques for improving the reverse denoising process of a diffusion model.

### SUMMARY

One embodiment of the present invention sets forth a technique for generating data. The technique includes perturbing a first time step embedding corresponding to a first time step in a reverse diffusion process associated with a trained diffusion model to generate a first perturbed time step embedding. The technique also includes generating, via execution of the trained diffusion model, a first perturbed time step score based on a first noise sample associated with the first time step and the first perturbed time step embedding. The technique further includes denoising the first noise sample based on the first perturbed time step score to produce a second noise sample.

One technical advantage of the disclosed techniques relative to the prior art is the ability to simulate the behavior of classifier-free guidance (CFG) without requiring a conditional diffusion model to learn an unconditional score function associated with a null condition. Accordingly, the disclosed techniques allow conditional diffusion models to be trained more quickly and/or using fewer resources than those trained using CFG techniques. The disclosed techniques may also, or instead, improve the performance of the trained conditional diffusion model by allowing resources that were previously consumed during training of a conditional diffusion model with a null condition under CFG to be reallocated to training the conditional diffusion model without the null condition. Another technical advantage of the disclosed techniques is the ability to provide guidance during conditional, unconditional, and/or multimodal generation by a diffusion model. Consequently, the disclosed techniques can be used to improve data generation by a wider range of diffusion models (e.g., pretrained diffusion models, conditional diffusion models, unconditional diffusion models, multimodal diffusion models, etc.) than CFG. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the guidance engine and generation engine of FIG. 1, according to various embodiments.

FIG. 3A illustrates the operation of the guidance engine and generation engine of FIG. 1 in performing independent condition guidance, according to various embodiments.

FIG. 3B illustrates the operation of the guidance engine and generation engine of FIG. 1 in performing time step guidance, according to various embodiments.

FIG. 4 is a flow diagram of method steps for generating data using independent condition guidance, according to various embodiments.

FIG. 5 is a flow diagram of method steps for generating data using time step guidance, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

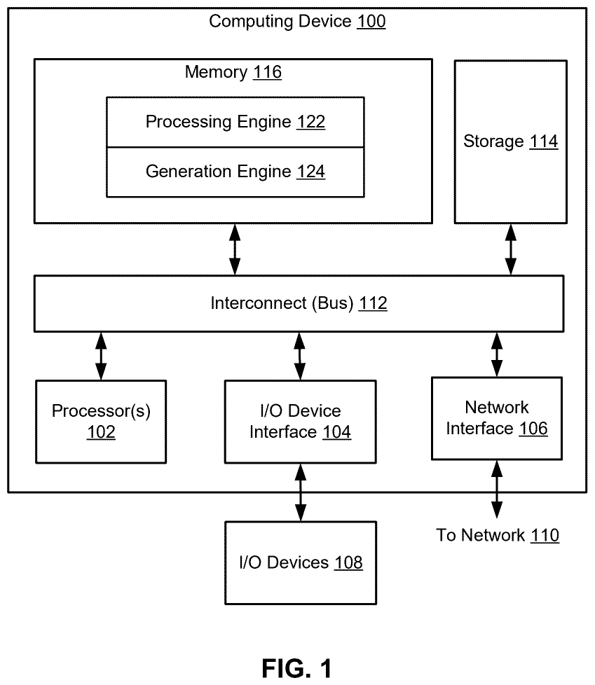

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a guidance engine 122 and a generation engine 124 that reside in memory 116.

It is noted that the computing device described herein is illustrative and that any other technically feasible configurations fall within the scope of the present disclosure. For example, multiple instances of guidance engine 122 and generation engine 124 may execute on a set of nodes in a distributed and/or cloud computing system to implement the functionality of computing device 100. In another example, guidance engine 122 and/or generation engine 124 may execute on various sets of hardware, types of devices, or environments to adapt guidance engine 122 and/or generation engine 124 to different use cases or applications. In a third example, guidance engine 122 and generation engine 124 may execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Guidance engine 122 and generation engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including guidance engine 122 and generation engine 124.

In one or more embodiments, guidance engine 122 and generation engine 124 include functionality to perform input-based guidance for diffusion models. The diffusion models perform a reverse denoising process that generates new data (e.g., images, text, audio, video, etc.) by iteratively converting random noise from a noise distribution into the new data over a series of time steps. The diffusion models may include conditional models that generate the new data based on corresponding conditions (e.g., text prompts, class labels, etc.) and/or unconditional models that generate the new data in the absence of corresponding conditions.

More specifically, guidance engine 122 and generation engine 124 use one or more guidance techniques to improve the quality of data samples generated by a diffusion model. These guidance techniques include independent condition guidance (ICG), in which a randomly sampled independent condition is included as input into a conditional diffusion model to simulate the behavior of an unconditional diffusion model in classifier-free guidance (CFG). These guidance techniques also, or instead, include time step guidance (TSG), in which a combination of perturbed and unperturbed time step embeddings inputted into a conditional and/or unconditional diffusion model is used to improve the quality of the generated data samples. Guidance engine 122 and generation engine 124 are described in further detail below.

### Input-Based Guidance for Diffusion Models

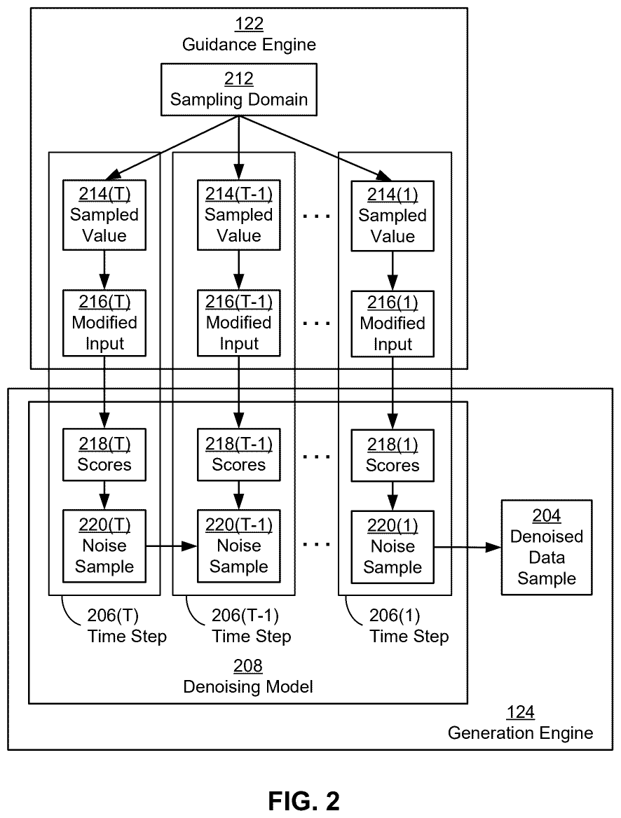

FIG. 2 is a more detailed illustration of guidance engine 122 and generation engine 124 of FIG. 1, according to various embodiments. As mentioned above, guidance engine 122 and generation engine 124 include functionality to perform input-based guidance for a diffusion model.

In one or more embodiments, the diffusion model includes a forward process of zₜ=x+σ(t)ϵ, where x˜p_{data}(x) is a data sample from a corresponding distribution, t∈[1, T] is a time step 206(1)-206(T-1), 206(T) (each of which is referred to individually herein as time step 206), and σ(t) is a noise schedule that determines how much information is destroyed at each time step, with σ(0)=0 and σ(1)=σₘₐₓ. This forward process corresponds to the ordinary differential equation (ODE) of:

$$d z = - \dot{σ} ( t ) σ ( t ) {∇}_{{z}_{t}} log {p}_{t} ( {z}_{t} ) dt \qquad ( 1 )$$

This forward process equivalently corresponds to a stochastic differential equation (SDE) given by:

$$d z = - \dot{σ} ( t ) σ ( t ) {∇}_{{z}_{t}} log {p}_{t} ( {z}_{t} ) d t - β ( t ) {σ ( t )}^{2} {∇}_{{z}_{t}} log {p}_{t} ( {z}_{t} ) dt + \sqrt{2 β ( t )} σ ( t ) d {ω}_{t} \qquad ( 2 )$$

In the above equation, dωₜ is a standard Wiener process, and pₜ(zₜ) is a time-dependent distribution of noise samples 220(1)-220(T-1), 220(T) (each of which is referred to individually herein as noise sample 220), with p₀=p_{data} and

$${p}_{1} = 𝒩 ( 0 , {σ}_{max}^{2} I ) .$$

Given access to the time-dependent score function ∇_{z}_{ₜ} log pₜ(zₜ), sampling from a data distribution p_{data} (e.g., a distribution of images, audio, video, text, and/or another type of data) can be performed via a reverse denoising process that solves the ODE or SDE backward in time (from time steps 206 t=T to t=1).

More specifically, the unknown score function ∇_{z}_{ₜ} log pₜ(zₜ) can be estimated via a neural denoising model 208 D_{θ}(zₜ, t) that is trained to predict a denoised data sample 204 corresponding to a data sample x from the data distribution based on a corresponding sequence of noise samples 220. This framework also allows for conditional generation by training a conditional denoising model 208 D_{θ}(zₜ, t, y) to accept additional input signals y, such as (but not limited to) class labels and/or text prompts.

Denoising model 208 may include a U-Net, transformer, and/or another type of neural network and/or machine learning architecture with identical input and output dimensionalities. During each time step 206 of the reverse denoising process, denoising model 208 generates one or more scores 218(1)-218(T-1), 218(T) (each of which is referred to individually herein as scores 218) that represent one or more evaluations of the estimated score function. These scores 218 are used to denoise a corresponding noise sample 220 for the same time step 206, resulting in a new noise sample 220 for the next time step. This process is repeated over a certain number of time steps 206 until denoised data sample 204 is obtained as the output of the reverse denoising process.

In one or more embodiments, given noise sample 220 zₜ at time step 206 t, a conditional denoising model 208 D_{θ}(zₜ, t, y) with parameters θ can be trained with a mean squared error (MSE) (also called denoising score matching) loss:

$${arg min}_{θ} {𝔼}_{t} [ {‖ {D}_{θ} ( {z}_{t} , t , y ) - x ‖}^{2} ] . \qquad ( 3 )$$

The trained conditional denoising model 208 approximates the time-dependent conditional score function ∇_{z}_{ₜ} log pₜ(zₜ|y) via the following:

$${∇}_{{z}_{t}} log {p}_{t} ( {z}_{t} \vert y ) \approx \frac{{D}_{θ} ( {z}_{t} , t , y ) - {z}_{t}}{{σ ( t )}^{2}} \qquad ( 4 )$$

To improve the quality of a given denoised data sample 204 generated via the reverse denoising process, classifier-free guidance (CFG) modifies the output of denoising model 208 at each time step 206 according to:

$${\hat{D}}_{θ} ( {z}_{t} , t , y ) = {D}_{θ} ( {z}_{t} , t , {y}_{null} ) + {w}_{CFG} ( {D}_{θ} ( {z}_{t} , t , y ) - {D}_{θ} ( {z}_{t} , t , {y}_{null} ) ) , \qquad ( 5 )$$

Where yₙᵤₗₗ=Ø is a null condition that causes denoising model 208 to act as an unconditional generator and w_{CFG}=1 corresponds to the unguided case. The unconditional model D_{θ}(zₜ, t, yₙᵤₗₗ) may be trained by randomly assigning the null condition yₙᵤₗₗ=Ø to the input of denoising model 208 with probability p (e.g., p∈[0.1,0.2]). Alternatively or additionally, CFG may be performed by training a conditional denoising model 208 D_{θ}(zₜ, t, y) and a separate unconditional denoising model 208 D_{θ}(zₜ, t, yₙᵤₗₗ).

In one or more embodiments, guidance engine 122 and generation engine 124 perform input-based guidance that improves the quality of denoised data sample 204 without requiring the use of CFG. As shown in FIG. 2, guidance engine 122 generates, for each time step 206 of the reverse denoising process, a different sampled value 214(1)-214(T-1), 214(T) (each of which is referred to individually herein as sampled value 214) by sampling from a corresponding sampling domain 212. For example, guidance engine 122 may generate sampled values 214 by sampling from a distribution, sample space, and/or another representation of valid sampled values 214 associated with input into denoising model 208.

Guidance engine 122 converts each sampled value 214 into a modified input 216(1)-216(T-1), 216(T) (each of which is referred to individually herein as modified input 216) into denoising model 208. Generation engine 124 uses denoising model 208 to convert each modified input 216 and/or one or more additional inputs (not shown in FIG. 2) into one or more scores 218 for the corresponding time step 206. Generation engine 124 then uses scores 218 outputted by denoising model 208 for that time step 206 to denoise a corresponding noise sample 220 for the same time step 206, resulting in a new noise sample 220 for the next time step 206. Guidance engine 122 and generation engine 124 repeat the process across remaining time steps 206 until denoised data sample 204 is produced.

In some embodiments, the input-based guidance includes independent condition guidance (ICG), which simulates the behavior of CFG without requiring the training of an unconditional denoising model 208 and/or a conditional denoising model 208 with a null condition. For example, ICG may be performed using a conditional denoising model 208 that has been trained using data samples paired with corresponding input conditions but has not been trained using the null condition.

In CFG, the conditional score ∇_{z}_{ₜ} log pₜ(zₜ|y) and the unconditional score ∇_{z}_{ₜ} log pₜ(zₜ) are used to guide the denoising process. Based on Bayes' theorem,

$${p}_{t} ( {z}_{t} \vert y ) = \frac{{p}_{t} ( y \vert {z}_{t} ) {p}_{t} ( {z}_{t} )}{{p}_{t} ( y )} ,$$

which gives:

$${∇}_{{z}_{t}} log {p}_{t} ( {z}_{t} \vert y ) = {∇}_{{z}_{t}} log {p}_{t} ( {z}_{t} ) + {∇}_{{z}_{t}} log {p}_{t} ( y \vert {z}_{t} ) \qquad ( 6 )$$

Replacing the condition with a random vector ŷ that is independent of the input zₜ leads to pₜ(ŷ|zₜ)=pₜ(ŷ), which results in:

$${∇}_{{z}_{t}} log {p}_{t} ( {z}_{t} \vert \hat{y} ) = {∇}_{{z}_{t}} log {p}_{t} ( {z}_{t} ) + {∇}_{{z}_{t}} log {p}_{t} ( \hat{y} ) = {∇}_{{z}_{t}} log {p}_{t} ( {z}_{t} ) \qquad ( 7 )$$

Consequently, an unconditional score can be estimated using a conditional denoising model 208 by replacing an input condition (e.g., a class label, text prompt, etc.) y with an independent vector ŷ. Thus, the conditional denoising model 208 may be used to bootstrap the score of the unconditional distribution by sampling, as a given sampled value 214, an input “independent condition” ŷ that is independent of zₜ.

Additionally, by knowing the conditional distribution pₜ(zₜ|y) for each y in the class-conditional case, the unconditional distribution can be implicitly obtained through pₜ(zₜ)=Σ_{y}pₜ(zₜ|y)p(y). While application of this formula involves multiple forward passes (one for each class), ICG can be used to derive the unconditional score using a single forward pass through denoising model 208. Thus, the sampling cost of ICG is equal to that of CFG.

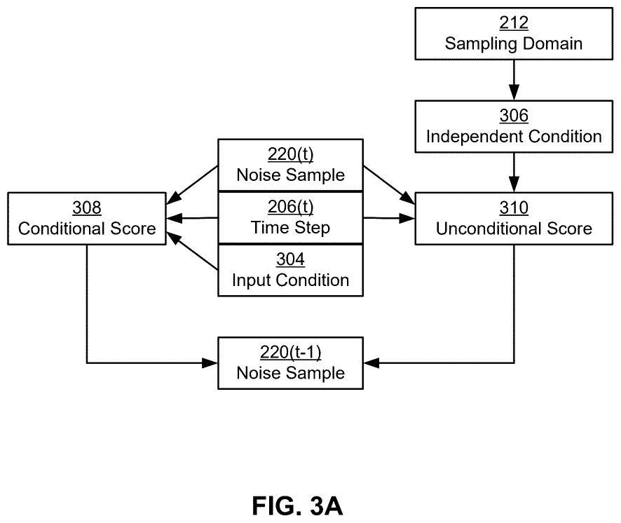

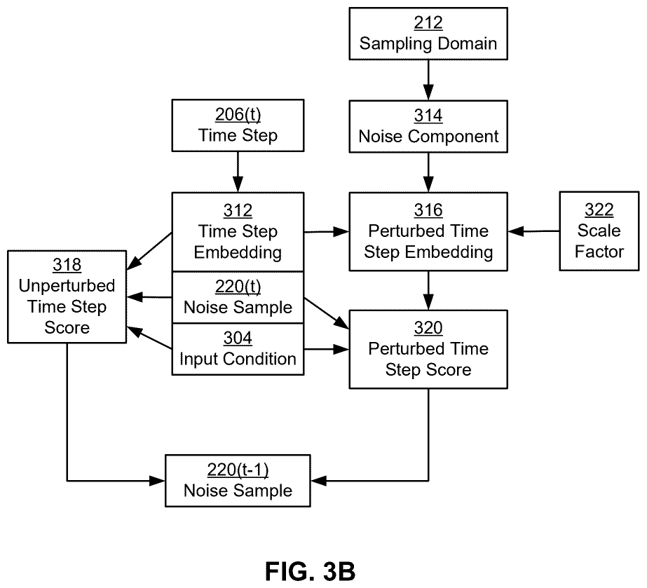

FIG. 3A illustrates the operation of guidance engine 122 and generation engine 124 of FIG. 1 in performing ICG, according to various embodiments. As shown in FIG. 3A, an independent condition 306 that corresponds to sampled value 214 for a given time step 206(t) is sampled from sampling domain 212.

As mentioned above, independent condition 306 corresponds to a condition that is independent of noise sample 220(t) for the same time step 206(t). Independent condition 306 may be generated by sampling from a noise distribution and/or conditioning space corresponding to sampling domain 212. For example, sampling domain 212 may include a Gaussian distribution with a standard deviation that is selected so that independent condition 306 ŷ matches the scale of a conditioning vector corresponding to an input condition 304 y. Sampling domain 212 may also, or instead, include a conditioning space of class labels, input tokens, and/or other types of conditions that can be specified as input into the reverse denoising process.

Once independent condition 306 is sampled, independent condition 306 is used as modified input 216 that replaces a null condition associated with an unconditional diffusion model and/or CFG. More specifically, independent condition 306, noise sample 220(t), and time step 206(t) are used as input into a conditional denoising model 208 that is not trained using the null condition to produce an unconditional score 310 that is included in a set of scores 218 for the same time step 206(t). Separately, noise sample 220(t), time step 206(t), and an input condition 304 (e.g., a class label, text prompt, and/or another type of condition that is used to steer the reverse denoising process) are inputted into the same conditional denoising model 208 to produce a conditional score 308 that is included in the same set of scores 218 for time step 206(t). Conditional score 308 and unconditional score 310 are then combined into an output that is used to denoise noise sample 220(t) into noise sample 220(t-1) for the next time step 206(t-1) in the reverse denoising process performed by denoising model 208.

In one or more embodiments, guidance engine 122 and generation engine 124 perform ICG using the following steps:

Require: w_{ICG} : ICG strength
Require: y: input condition
1: Initial noise sample: z_{T}~ [symbol] (0, I)
2: for t = T, ..., 1 do
3: Pick a random ŷ independent of the input
4: Compute the ICG guided output at t:
\hat{D}_{ICG} (zₜ, t, y) = D(zₜ, t, ŷ) + w_{ICG} (D(zₜ, t, y) − D(zₜ, t, ŷ)).
5: Perform one sampling step:
zₜ₋₁ = diffusion_reverse(\hat{D}_{ICG}, zₜ, t).
6: end for
7: return z₀

In step 1, an initial noise sample 220(T) is sampled from a Gaussian distribution with 0 mean and unit variance. Next, steps 2-6 are performed from time step 206(T) to time step 206(1) to iteratively denoise the initial noise sample 220(T). During a current time step 206(t), step 3 is performed to sample a random independent condition 306 from sampling domain 212. Step 4 is performed to generate output of denoising model 208 as a weighted combination of conditional score 308 D(zₜ, t, y), which is computed using input condition 304 y; unconditional score 310 D(zₜ, t, ŷ), which is computed using independent condition 306 ŷ; and a weight w_{ICG} that represents the strength of ICG. Step 5 is performed to denoise a corresponding noise sample 220(t) zₜ using the output generated in step 4, resulting in a new noise sample 220(t-1) zₜ₋₁ for the next time step 206(t-1). After the denoising process has been performed for all time steps 206, denoised data sample 204 z₀ is returned.

In some embodiments, the input-based guidance performed by guidance engine 122 and generation engine 124 includes time step guidance (TSG). Unlike CFG, TSG is applicable to both conditional and unconditional diffusion models.

In TSG, the output of denoising model 208 at time step 206 t is computed using a weighted combination of a first embedding of the unperturbed time step t and a second perturbed embedding of the same time step \tilde{t}:

$${\hat{D}}_{θ} ( {z}_{t} , t ) = {D}_{θ} ( {z}_{t} , \tilde{t} ) + {w}_{TSG} ( {D}_{θ} ( {z}_{t} , t ) - {D}_{θ} ( {z}_{t} , \tilde{t} ) ) \qquad ( 8 )$$

Because altering the time step embedding at time step 206 t leads to denoised outputs that represent either insufficient or excess noise removal, these denoised outputs can be used to steer denoising model 208 away from undesirable predictions, thereby increasing the accuracy of the predicted scores 218 at each time step 206.

More specifically, let \tilde{t}=t+Δt, where Δt is a small perturbation. Using a Taylor expansion results in

$${D}_{θ} ( {z}_{t} , \tilde{t} ) = {D}_{θ} ( {z}_{t} , j ) + \frac{\partial {D}_{θ} ( {z}_{t} , t )}{\partial t} Δ t .$$

### Hence,

$${D}_{θ} ( {z}_{t} , \tilde{t} ) = {D}_{θ} ( {z}_{t} , t ) + ( 1 - {w}_{TSG} ) \frac{\partial {D}_{θ} ( {z}_{t} , t )}{\partial t} Δ t .$$

Based on Equation 4, the score function is equal to

$${∇}_{{z}_{t}} log {\hat{p}}_{t} ( {z}_{t} ) = {∇}_{{z}_{t}} log {p}_{t} ( {z}_{t} ) + \frac{1 - {w}_{TSG}}{{σ ( t )}^{2}} \frac{\partial {D}_{θ} ( {z}_{t} , t )}{\partial t} Δ t \qquad ( 9 )$$

By following the Euler sampling step for solving Equation 1 (i.e., defining the update rule as zₜ₋₁=zₜ+ηₜ∇_{z}_{ₜ} log \hat{p}ₜ(zₜ)), the modified sampling step after TSG is equal to:

$${z}_{t - 1} = {z}_{t} + {η}_{t} {∇}_{{z}_{t}} log {p}_{t} ( {z}_{t} ) + {η}_{t} \frac{1 - {w}_{TSG}}{{σ ( t )}^{2}} \frac{\partial {D}_{θ} ( {z}_{t} , t )}{\partial t} Δ t \qquad ( 10 )$$

Assuming that Δt is a Gaussian random variable with zero mean, the update rule resembles a Langevin dynamics step, where the noise strength is determined based on the behavior of denoising model 208, as represented by

$$\frac{\partial {D}_{θ} ( {z}_{t} , t )}{\partial t} .$$

Because Langevin dynamics is known to increase the quality of sampling from a given distribution by compensating for the errors happening at each sampling step, TSG also behaves similarly in terms of first-order approximation and therefore also improves the quality of denoised data sample 204 generated by denoising model 208.

FIG. 3B illustrates the operation of guidance engine 122 and generation engine 124 of FIG. 1 in performing TSG, according to various embodiments. As shown in FIG. 3B, a noise component 314 that corresponds to sampled value 214 for a given time step 206(t) is sampled from sampling domain 212. Noise component 314 is combined with a time step embedding 312 for that time step 206(t) and a scale factor 322 to produce a perturbed time step embedding 316.

As mentioned above, perturbed time step embedding 316 corresponds to a perturbed version of time step embedding 312 that leads to insufficient or excess noise removal for time step 206. For example, perturbed time step embedding 316 may correspond to a perturbation of time step embedding 312 that reflects a positive or negative shift in time step 206(t).

For example, perturbed time step embedding 316 may be computed using the following:

$${\tilde{t}}_{emb} = {t}_{emb} + s {t}^{α} n \qquad ( 11 )$$

In the above equation, n˜ [symbol] (0, I) corresponds to noise component 314 and is sampled from a Gaussian noise distribution. Noise component 314 is multiplied by scale factor 322 of st^{α}, where s is a coefficient, t denotes time step 206(t), and α is an exponent applied to time step 206(t). The result is then added to time step embedding 312 to produce perturbed time step embedding 316 \tilde{t}_{emb}. The coefficient s and exponent t may be selected to scale noise component 314 in a way that is comparable to the scale of time step embedding 312 t_{emb}.

Once perturbed time step embedding 316 is computed, perturbed time step embedding 316 is used as modified input 216 that replaces time step embedding 312 for a corresponding conditional and/or unconditional evaluation of denoising model 208. More specifically, perturbed time step embedding 316, noise sample 220(t), and input condition 304 are used as input into denoising model 208 to produce a perturbed time step score 320 that is included in a set of scores 218 for time step 206(t). Separately, the unperturbed time step embedding 312, noise sample 220(t), and the same input condition 304 are inputted into denoising model 208 to produce an unperturbed time step score 318 that is included in the same set of scores 218 for time step 206(t). When denoising model 208 corresponds to an unconditional diffusion model, input condition 304 may be set to a null condition. When denoising model 208 corresponds to a conditional diffusion model, input condition 304 may be set to a non-null condition. Unperturbed time step score 318 and perturbed time step score 320 are then combined into an output that is used to denoise noise sample 220(t) into noise sample 220(t-1) for the next time step 206(t-1).

In one or more embodiments, guidance engine 122 and generation engine 124 perform TSG using the following steps:

```
Require: w_{TSG} : TSG strength
Require: (s, α): TSG hyperparameters
Require: y: input condition (optional)
1: Initial noise sample: z_{T}~ [symbol]  (0, I)
2: for t = T, ...,1 do
3: Perturb the time step embedding t_{emb} to get \tilde{t}_{emb}
4: Compute the ISG guided output at t:
  \hat{D}_{TSG}(zₜ, t, y) = D(zₜ, \tilde{t}_{emb}, y) + w_{TSG} (D (zₜ, t_{emb}, y) − D(zₜ, \tilde{t}_{emb}, y)).
5: Perform one sampling step:
  zₜ₋₁ = diffusion_reverse(\hat{D}_{TSG}, zₜ, t).
6: end for
7: return z₀
```

In step 1, an initial noise sample 220(T) is sampled from a Gaussian distribution with 0 mean and unit variance. Next, steps 2-6 are performed from time step 206(T) to time step 206(1) to iteratively denoise the initial noise sample 220(T). During a current time step 206(t), step 3 is performed to convert time step embedding 312 into perturbed time step embedding 316 (e.g., using noise component 314 and scale factor 322). Step 4 is performed to generate output of denoising model 208 as a weighted combination of unperturbed time step score 318 D(zₜ, t_{emb}, y), which is computed using the original unperturbed time step embedding 312 t_{emb}; perturbed time step score 320 D(zₜ, \tilde{t}_{emb}, y), which is computed using perturbed time step embedding 316 \tilde{t}_{emb}; and a weight w_{TSG} that represents the strength of TSG. Step 5 is performed to denoise a corresponding noise sample 220(t) zₜ using the output generated in step 4, resulting in a new noise sample 220(t-1) zₜ₋₁ for the next time step 206(t-1). After the denoising process has been performed for all time steps 206, denoised data sample 204 z₀ is returned.

In one or more embodiments, ICG and TSG are applied and/or combined in various ways to provide guidance to denoising model 208. First, the reverse denoising process associated with denoising model 208 may involve combining ICG and TSG. For example, ICG may be used to generate independent condition 306 ŷ for a given time step 206, and TSG may be used to generate perturbed time step embedding 316 \tilde{t}_{emb} for the same time step 206. Denoising model 208 may be used to generate an “unconditional unperturbed time step score” D(zₜ, t_{emb}, ŷ) for that time step 206 based on the generated independent condition 306 and a non-perturbed time step embedding 312 corresponding to that time step 206. Denoising model 208 may also, or instead, be used to generate a “conditional perturbed time step score” D(zₜ, \tilde{t}_{emb}, y) for that time step 206 based on input condition 304 and perturbed time step embedding 316. Denoising model 208 may also, or instead, be used to generate a “conditional unperturbed time step score” D(zₜ, t_{emb}, y) for that time step based on input condition 304 and the non-perturbed time step embedding 312. The unconditional perturbed time step score, conditional perturbed time step score, and/or conditional unperturbed time step score may then be combined with one or more corresponding weights into a guided output that is used to denoise noise sample 220(t) zₜ into noise sample 220(t-1) zₜ₋₁.

Second, ICG and/or TSG may be applied to some or all layers of denoising model 208 and/or some or all time steps 206 in the reverse denoising process. For example, a given perturbed time step embedding 316 and/or independent condition 306 may be inputted into a subset of layers in denoising model 208 (e.g., the first, middle, and/or last X layers; one or more “blocks” of contiguous layers; every Y layers; etc.), and the unperturbed time step embedding 312 and/or input condition 304 may be inputted into remaining layers in denoising model 208. In another example, a different independent condition 306 may be sampled for each time step 206 in the reverse denoising process, or the same independent condition 306 may be used for multiple contiguous and/or non-contiguous time steps 206 in the reverse denoising process. In a third example, ICG may be used in a first set of time steps 206 in the reverse denoising process, and TSG may be used in a second set of time steps 206 in the reverse denoising process. The first and second set of time steps 206 may overlap with one another and/or be disjoint. Each set of time steps 206 may also include contiguous or non-contiguous time steps 206; a certain number of beginning, middle, and/or ending time steps 206 in the reverse diffusion process; a randomly selected set of time steps 206 (e.g., by determining whether ICG and/or TSG should be applied at a given time step 206 with a certain probability); and/or time steps 206 that are determined and/or selected via other techniques.

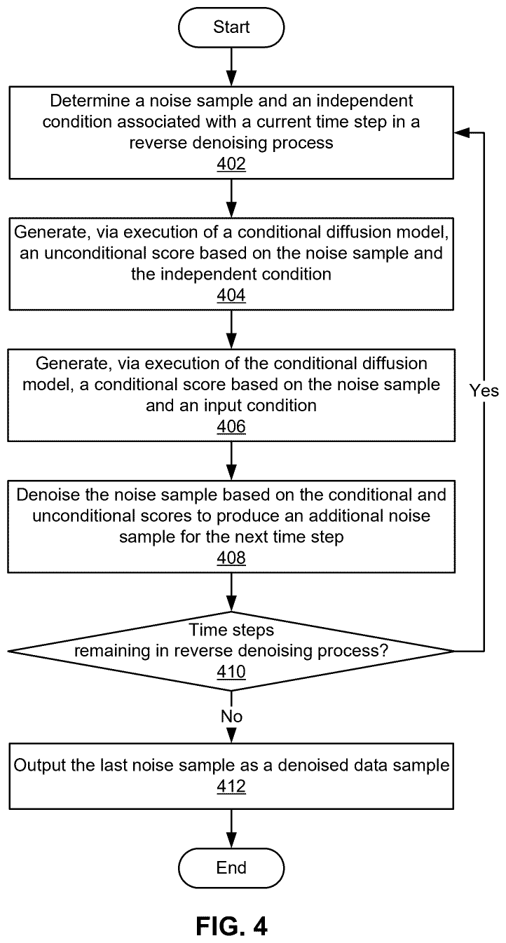

FIG. 4 is a flow diagram of method steps for generating data using ICG, according to various embodiments. Although the method steps are described in conjunction with the systems of FIGS. 1-2, persons skilled in the art will understand that any system configured to perform some or all of the method steps in any order falls within the scope of the present disclosure.

As shown, in step 402, guidance engine 122 determines a noise sample and an independent condition associated with a current time step in a reverse denoising process. For example, guidance engine 122 may initially sample the noise sample for a first time step t=T from a Gaussian noise distribution. Guidance engine 122 may also sample the independent condition from a noise distribution, conditioning space, and/or another type of sampling domain associated with conditions that can be used to generate data.

In step 404, generation engine 124 generates, via execution of a conditional diffusion model (e.g., denoising model 208 of FIG. 2), an unconditional score based on the noise sample and the independent condition. For example, generation engine 124 may input the noise sample, independent condition, and an embedding and/or another representation of the current time step into the conditional diffusion model. Based on this input, the conditional diffusion model may output the unconditional score.

The conditional diffusion model may be trained using data samples from a data distribution and conditions paired with the data samples. The conditional diffusion model is not required to be trained using a null condition with a certain probability (e.g., as performed during CFG). Instead, the independent condition is used to simulate the unconditional branch of CFG without extra training associated with CFG.

In step 406, generation engine 124 generates, via execution of the conditional diffusion model, a conditional score based on the noise sample and an input condition. For example, generation engine 124 may input the noise sample, input condition, and an embedding and/or another representation of the current time step into the conditional diffusion model. The embedding may optionally be perturbed using TSG (as described above) to combine ICG and TSG in the same time step.

In step 408, generation engine 124 denoises the noise sample based on the conditional and unconditional scores to produce an additional noise sample for the next time step. For example, generation engine 124 may compute a weighted combination of the conditional and unconditional scores and combine the result with the noise sample for the current time step t to produce the additional noise sample for the next time step t-1.

In step 410, guidance engine 122 and/or generation engine 124 determine whether or not time steps remain in the reverse denoising process. For example, guidance engine 122 and/or generation engine 124 may determine that time steps remain in the reverse denoising process while a final time step (e.g., t=1) has not been reached. While guidance engine 122 and/or generation engine 124 determine that time steps remain in the reverse diffusion process, guidance engine 122 and/or generation engine 124 repeat steps 402, 404, 406, 408, and 410 to continue the reverse denoising process over subsequent time steps.

Once guidance engine 122 and/or generation engine 124 determine in step 410 that no time steps remain in the reverse denoising process, generation engine 124 performs step 412, in which generation engine 124 outputs the last noise sample as a denoised data sample. For example, generation engine 124 may output the noise sample z₀ generated during the last time step t=1 as image data, audio data, video data, text data, and/or another type of denoised data sample produced by the reverse denoising process.

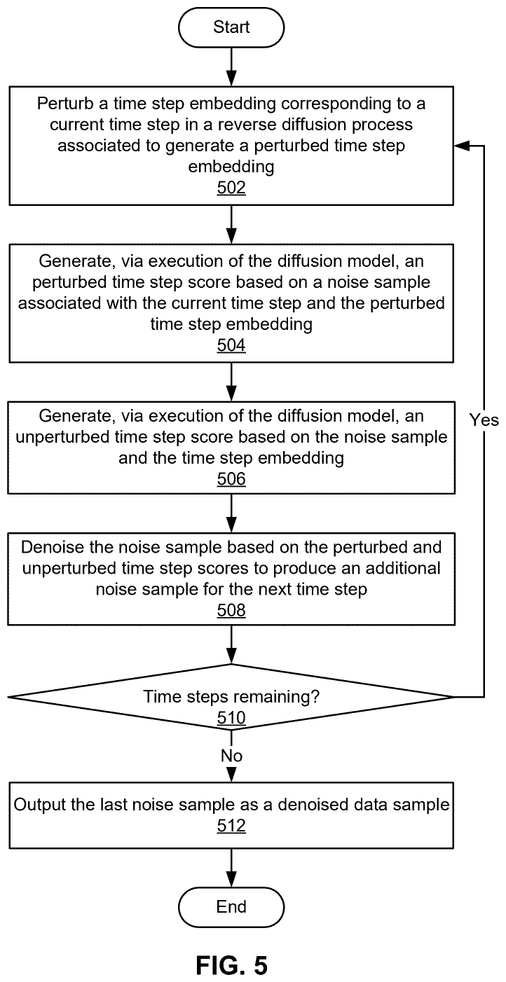

FIG. 5 is a flow diagram of method steps for generating data using TSG, according to various embodiments. Although the method steps are described in conjunction with the systems of FIGS. 1-2, persons skilled in the art will understand that any system configured to perform some or all of the method steps in any order falls within the scope of the present disclosure.

As shown, in step 502, guidance engine 122 perturbs a time step embedding corresponding to a current time step in a reverse diffusion process to generate a perturbed time step embedding. For example, guidance engine 122 may use one or more embedding layers to convert the current time step into the time step embedding. Guidance engine 122 may also sample a noise component from a noise distribution and scale the noise component by a scale factor that includes the current time step, an exponent, a coefficient, and/or another term.

In step 504, generation engine 124 generates, via execution of a diffusion model (e.g., denoising model 208 of FIG. 2), a perturbed time step score based on a noise sample associated with the current time step and the perturbed time step embedding. For example, generation engine 124 may input the noise sample, a null and/or non-null input condition, and the perturbed time step embedding into the diffusion model. Based on this input, the diffusion model may output the perturbed time step score.

The diffusion model may include a conditional diffusion model that is trained using data samples from a data distribution and conditions paired with the data samples. The diffusion model may also, or instead, include an unconditional diffusion model that generates and/or denoises data in the absence of a corresponding condition.

In step 506, generation engine 124 generates, via execution of the diffusion model, an unperturbed time step score based on the noise sample and the time step embedding. For example, generation engine 124 may input the noise sample, a null and/or non-null input condition, and the unperturbed time step embedding for the current time step into the diffusion model. The input condition may optionally include an independent condition that is generated using ICG (as described above) to combine ICG and TSG in the same time step.

In step 508, generation engine 124 denoises the noise sample based on the perturbed and unperturbed time step scores to produce an additional noise sample for the next time step. For example, generation engine 124 may compute a weighted combination of the perturbed and unperturbed time step scores and combine the result with the noise sample for the current time step t to produce the additional noise sample for the next time step t-1.

In step 510, guidance engine 122 and/or generation engine 124 determine whether or not time steps remain in the reverse denoising process. For example, guidance engine 122 and/or generation engine 124 may determine that time steps remain in the reverse denoising process while a final time step (e.g., t=1) has not been reached. While guidance engine 122 and/or generation engine 124 determine that time steps remain in the reverse diffusion process, guidance engine 122 and/or generation engine 124 repeat steps 502, 504, 506, 508, and 510 to continue the reverse denoising process over subsequent time steps.

Once guidance engine 122 and/or generation engine 124 determine in step 510 that no time steps remain in the reverse denoising process, generation engine 124 performs step 512, in which generation engine 124 outputs the last noise sample as a denoised data sample. For example, generation engine 124 may output the noise sample z₀ generated during the last time step t=1 as image data, audio data, video data, text data, and/or another type of denoised data sample produced by the reverse denoising process.

In sum, the disclosed techniques perform input-based guidance for diffusion models. The diffusion models perform a reverse denoising process that generates new data (e.g., images, text, audio, video, etc.) by iteratively converting random noise from a noise distribution into the new data over a series of time steps. The diffusion models may include conditional models that generate the new data based on corresponding conditions (e.g., text prompts, class labels, etc.) and/or unconditional models that generate the new data in the absence of corresponding conditions.

The input-based guidance includes independent condition guidance (ICG), in which a randomly sampled independent condition is included as input into a conditional diffusion model to simulate the behavior of classifier-free guidance in lieu of training a separate unconditional model to perform classifier-free guidance (CFG). The input-based guidance also, or instead, includes time step guidance (TSG), in which time step embeddings inputted into a conditional and/or unconditional diffusion model are perturbed in the positive and/or negative direction to improve the quality of the generated data samples.

One technical advantage of the disclosed techniques relative to the prior art is the ability to simulate the behavior of classifier-free guidance (CFG) without requiring a conditional diffusion model to learn an unconditional score function associated with a null condition. Accordingly, the disclosed techniques allow conditional diffusion models to be trained more quickly and/or using fewer resources than those trained using CFG techniques. The disclosed techniques may also, or instead, improve the performance of the trained conditional diffusion model by allowing resources that were previously consumed during training of a conditional diffusion model with a null condition under CFG to be reallocated to training the conditional diffusion model without the null condition. Another technical advantage of the disclosed techniques is the ability to provide guidance during conditional, unconditional, and/or multimodal generation by a diffusion model. Consequently, the disclosed techniques can be used to improve data generation by a wider range of diffusion models (e.g., pretrained diffusion models, conditional diffusion models, unconditional diffusion models, multimodal diffusion models, etc.) than CFG. These technical advantages provide one or more technological improvements over prior art approaches.

1. In some embodiments, a computer-implemented method for generating data comprises determining (i) a first noise sample associated with a trained conditional diffusion model and (ii) a first independent condition; generating, via execution of the trained conditional diffusion model, a first unconditional score based on the first noise sample and the first independent condition; and denoising the first noise sample based on the first unconditional score to produce a second noise sample.

2. The computer-implemented method of clause 1, further comprising determining, via execution of the trained conditional diffusion model, a first conditional score based on the first noise sample and an input condition; and further denoising the first noise sample based on the first conditional score to produce the second noise sample.

3. The computer-implemented method of any of clauses 1-2, further comprising perturbing a time step embedding associated with the input condition to generate a perturbed time step embedding; and further determining the first conditional score based on the perturbed time step embedding.

4. The computer-implemented method of any of clauses 1-3, wherein the first noise sample is denoised using a weighted combination associated with the first conditional score and the first unconditional score.

5. The computer-implemented method of any of clauses 1-4, further comprising training a conditional diffusion model using a plurality of data samples and a plurality of conditions associated with the plurality of data samples to generate the trained conditional diffusion model.

6. The computer-implemented method of any of clauses 1-5, further comprising generating, via execution of the trained conditional diffusion model, a second unconditional score based on the second noise sample and a second independent condition; and denoising the second noise sample based on the second unconditional score to produce a third noise sample.

7. The computer-implemented method of any of clauses 1-6, wherein determining the first independent condition comprises sampling the first independent condition from a conditioning space.

8. The computer-implemented method of any of clauses 1-7, wherein the conditioning space comprises at least one of a set of classes or a set of tokens.

9. The computer-implemented method of any of clauses 1-8, wherein determining the first independent condition comprises sampling the first independent condition from a noise distribution.

10. The computer-implemented method of any of clauses 1-9, wherein the noise distribution comprises a Gaussian distribution.

11. In some embodiments, one or more non-transitory computer-readable media store instructions that, when executed by one or more processors, cause the one or more processors to perform the steps of determining (i) a first noise sample associated with a trained conditional diffusion model and (ii) a first independent condition; generating, via execution of the trained conditional diffusion model, a first unconditional score based on the first noise sample and the first independent condition; and denoising the first noise sample based on the first unconditional score to produce a second noise sample.

12. The one or more non-transitory computer-readable media of clause 11, wherein the instructions further cause the one or more processors to perform the steps of determining, via execution of the trained conditional diffusion model, a first conditional score based on the first noise sample and an input condition; and further denoising the first noise sample based on the first conditional score, the first unconditional score, and a guidance scale to produce the second noise sample.

13. The one or more non-transitory computer-readable media of any of clauses 11-12, wherein the instructions further cause the one or more processors to perform the steps of perturbing a time step embedding associated with the input condition to generate a perturbed time step embedding; and further determining the first conditional score based on the perturbed time step embedding.

14. The one or more non-transitory computer-readable media of any of clauses 11-13, wherein the time step embedding is perturbed using at least one of a scale factor or a noise component.

15. The one or more non-transitory computer-readable media of any of clauses 11-14, wherein the instructions further cause the one or more processors to perform the step of training a conditional diffusion model using a plurality of data samples and a plurality of conditions associated with the plurality of data samples to generate the trained conditional diffusion model.

16. The one or more non-transitory computer-readable media of any of clauses 11-15, wherein the instructions further cause the one or more processors to perform the steps of generating, via execution of the trained conditional diffusion model, a second unconditional score based on the second noise sample and the first independent condition; and denoising the second noise sample based on the second unconditional score to produce a third noise sample.

17. The one or more non-transitory computer-readable media of any of clauses 11-16, wherein the instructions further cause the one or more processors to perform the step of denoising the second noise sample to generate a denoised data sample, wherein the denoised data sample comprises at least one of image data, video data, text data, or audio data.

18. The one or more non-transitory computer-readable media of any of clauses 11-17, wherein determining the first independent condition comprises sampling the first independent condition from at least one of a conditioning space or a noise distribution.

19. The one or more non-transitory computer-readable media of any of clauses 11-18, wherein determining the first noise sample comprises denoising a third noise sample based on a second independent condition to generate the first noise sample.

20. In some embodiments, a system comprises one or more memories that store instructions, and one or more processors that are coupled to the one or more memories and, when executing the instructions, are configured to perform the steps of determining (i) a first noise sample associated with a trained conditional diffusion model and (ii) a first independent condition; generating, via execution of the trained conditional diffusion model, a first unconditional score based on the first noise sample and the first independent condition; and denoising the first noise sample based on the first unconditional score to produce a second noise sample.

21. In some embodiments, a computer-implemented method for generating data comprises perturbing a first time step embedding corresponding to a first time step in a reverse diffusion process associated with a trained diffusion model to generate a first perturbed time step embedding; generating, via execution of the trained diffusion model, a first perturbed time step score based on a first noise sample associated with the first time step and the first perturbed time step embedding; and denoising the first noise sample based on the first perturbed time step score to produce a second noise sample.

22. The computer-implemented method of clause 21, further comprising determining, via execution of the trained diffusion model, a first unperturbed time step score based on the first noise sample and the first time step embedding; and further denoising the first noise sample based on the first unperturbed time step score to produce the second noise sample.

23. The computer-implemented method of any of clauses 21-22, further comprising determining an independent condition associated with the first noise sample; and further determining the first unperturbed time step score based on the independent condition.

24. The computer-implemented method of any of clauses 21-23, wherein the first unperturbed time step score is further determined based on the first time step embedding.

25. The computer-implemented method of any of clauses 21-24, further comprising training a diffusion model using a plurality of data samples and a plurality of unperturbed time step embeddings to generate the trained diffusion model.

26. The computer-implemented method of any of clauses 21-25, further comprising generating, via execution of the trained diffusion model, a second perturbed time step score based on the second noise sample and a second time step embedding corresponding to a second time step in the reverse diffusion process; and denoising the second noise sample based on the second perturbed time step score to produce a third noise sample.

27. The computer-implemented method of any of clauses 21-26, wherein generating the first perturbed time step score comprises inputting the first perturbed time step embedding into a subset of layers included in the trained diffusion model.

28. The computer-implemented method of any of clauses 21-27, wherein perturbing the first time step embedding comprises combining the first time step embedding with a noise component.

29. The computer-implemented method of any of clauses 21-28, wherein perturbing the first time step embedding further comprises scaling the noise component prior to combining the first time step embedding with the noise component.

30. The computer-implemented method of any of clauses 21-29, wherein the trained diffusion model comprises at least one of a conditional diffusion model or an unconditional diffusion model.

31. In some embodiments, one or more non-transitory computer-readable media store instructions that, when executed by one or more processors, cause the one or more processors to perform the steps of perturbing a first time step embedding corresponding to a first time step in a reverse diffusion process associated with a trained diffusion model to generate a first perturbed time step embedding; generating, via execution of the trained diffusion model, a first perturbed time step score based on a first noise sample associated with the first time step and the first perturbed time step embedding; and denoising the first noise sample based on the first perturbed time step score to produce a second noise sample.

32. The one or more non-transitory computer-readable media of clause 31, wherein the instructions further cause the one or more processors to perform the steps of determining, via execution of the trained diffusion model, a first unperturbed time step score based on the first noise sample and the first time step embedding; and further denoising the first noise sample based on the first unperturbed time step score to produce the second noise sample.

33. The one or more non-transitory computer-readable media of any of clauses 31-32, wherein the instructions further cause the one or more processors to perform the steps of determining an independent condition associated with the first noise sample; and further determining the first unperturbed time step score based on the independent condition.

34. The one or more non-transitory computer-readable media of any of clauses 31-33, wherein the independent condition is sampled from at least one of a noise distribution or a conditioning space.

35. The one or more non-transitory computer-readable media of any of clauses 31-34, wherein the instructions further cause the one or more processors to perform the step of training a diffusion model using a data sample and a plurality of unperturbed time step embeddings associated with the data sample to generate the trained diffusion model.

36. The one or more non-transitory computer-readable media of any of clauses 31-35, wherein generating the first perturbed time step score comprises inputting the first perturbed time step embedding into one or more initial layers in the trained diffusion model; inputting the first time step embedding into one or more additional layers in the trained diffusion model, wherein the one or more additional layers follow the one more initial layers within the trained diffusion model; and outputting, via the trained diffusion model, the first perturbed time step score based on the inputted first perturbed time step embedding and the inputted first time step embedding.

37. The one or more non-transitory computer-readable media of any of clauses 31-36, wherein the instructions further cause the one or more processors to perform the step of denoising the second noise sample to generate a denoised data sample, wherein the denoised data sample comprises at least one of image data, video data, text data, or audio data.

38. The one or more non-transitory computer-readable media of any of clauses 31-37, wherein perturbing the first time step embedding comprises sampling a noise component from a noise distribution; combining the noise component with a scale factor to generate a scaled noise component; and combining the scaled noise component with the first time step embedding.

39. The one or more non-transitory computer-readable media of any of clauses 31-38, wherein the scale factor comprises at least one of the first time step, an exponent, or a coefficient.

40. In some embodiments, a system comprises one or more memories that store instructions, and one or more processors that are coupled to the one or more memories and, when executing the instructions, are configured to perform the steps of perturbing a first time step embedding corresponding to a first time step in a reverse diffusion process associated with a trained diffusion model to generate a first perturbed time step embedding; generating, via execution of the trained diffusion model, a first perturbed time step score based on a first noise sample associated with the first time step and the first perturbed time step embedding; and denoising the first noise sample based on the first perturbed time step score to produce a second noise sample.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating data, the method comprising:
perturbing a first time step embedding corresponding to a first time step in a reverse diffusion process associated with a trained diffusion model to generate a first perturbed time step embedding;
generating, via execution of the trained diffusion model, a first perturbed time step score based on a first noise sample associated with the first time step and the first perturbed time step embedding; and
denoising the first noise sample based on the first perturbed time step score to produce a second noise sample.

2. The computer-implemented method of claim 1, further comprising:
determining, via execution of the trained diffusion model, a first unperturbed time step score based on the first noise sample and the first time step embedding; and
further denoising the first noise sample based on the first unperturbed time step score to produce the second noise sample.

3. The computer-implemented method of claim 2, further comprising:
determining an independent condition associated with the first noise sample; and
further determining the first unperturbed time step score based on the independent condition.

4. The computer-implemented method of claim 2, wherein the first unperturbed time step score is further determined based on the first time step embedding.

5. The computer-implemented method of claim 1, further comprising training a diffusion model using a plurality of data samples and a plurality of unperturbed time step embeddings to generate the trained diffusion model.

6. The computer-implemented method of claim 1, further comprising:
generating, via execution of the trained diffusion model, a second perturbed time step score based on the second noise sample and a second time step embedding corresponding to a second time step in the reverse diffusion process; and
denoising the second noise sample based on the second perturbed time step score to produce a third noise sample.

7. The computer-implemented method of claim 1, wherein generating the first perturbed time step score comprises inputting the first perturbed time step embedding into a subset of layers included in the trained diffusion model.

8. The computer-implemented method of claim 1, wherein perturbing the first time step embedding comprises combining the first time step embedding with a noise component.

9. The computer-implemented method of claim 8, wherein perturbing the first time step embedding further comprises scaling the noise component prior to combining the first time step embedding with the noise component.

10. The computer-implemented method of claim 1, wherein the trained diffusion model comprises at least one of a conditional diffusion model or an unconditional diffusion model.

11. One or more non-transitory computer-readable media storing instructions that, when executed by one or more processors, cause the one or more processors to perform the steps of:
perturbing a first time step embedding corresponding to a first time step in a reverse diffusion process associated with a trained diffusion model to generate a first perturbed time step embedding;
generating, via execution of the trained diffusion model, a first perturbed time step score based on a first noise sample associated with the first time step and the first perturbed time step embedding; and
denoising the first noise sample based on the first perturbed time step score to produce a second noise sample.

12. The one or more non-transitory computer-readable media of claim 11, wherein the instructions further cause the one or more processors to perform the steps of:
determining, via execution of the trained diffusion model, a first unperturbed time step score based on the first noise sample and the first time step embedding; and
further denoising the first noise sample based on the first unperturbed time step score to produce the second noise sample.

13. The one or more non-transitory computer-readable media of claim 12, wherein the instructions further cause the one or more processors to perform the steps of:
determining an independent condition associated with the first noise sample; and
further determining the first unperturbed time step score based on the independent condition.

14. The one or more non-transitory computer-readable media of claim 13, wherein the independent condition is sampled from at least one of a noise distribution or a conditioning space.

15. The one or more non-transitory computer-readable media of claim 11, wherein the instructions further cause the one or more processors to perform the step of training a diffusion model using a data sample and a plurality of unperturbed time step embeddings associated with the data sample to generate the trained diffusion model.

16. The one or more non-transitory computer-readable media of claim 11, wherein generating the first perturbed time step score comprises:
inputting the first perturbed time step embedding into one or more initial layers in the trained diffusion model;
inputting the first time step embedding into one or more additional layers in the trained diffusion model, wherein the one or more additional layers follow the one more initial layers within the trained diffusion model; and
outputting, via the trained diffusion model, the first perturbed time step score based on the inputted first perturbed time step embedding and the inputted first time step embedding.

17. The one or more non-transitory computer-readable media of claim 11, wherein the instructions further cause the one or more processors to perform the step of denoising the second noise sample to generate a denoised data sample, wherein the denoised data sample comprises at least one of image data, video data, text data, or audio data.

18. The one or more non-transitory computer-readable media of claim 11, wherein perturbing the first time step embedding comprises:
sampling a noise component from a noise distribution;
combining the noise component with a scale factor to generate a scaled noise component; and
combining the scaled noise component with the first time step embedding.

19. The one or more non-transitory computer-readable media of claim 18, wherein the scale factor comprises at least one of the first time step, an exponent, or a coefficient.

20. A system, comprising:
one or more memories that store instructions, and
one or more processors that are coupled to the one or more memories and, when executing the instructions, are configured to perform the steps of:
perturbing a first time step embedding corresponding to a first time step in a reverse diffusion process associated with a trained diffusion model to generate a first perturbed time step embedding;
generating, via execution of the trained diffusion model, a first perturbed time step score based on a first noise sample associated with the first time step and the first perturbed time step embedding; and
denoising the first noise sample based on the first perturbed time step score to produce a second noise sample.
